(19) United States
(12) Patent Application Publication
(10) Pub. No.: US 2007/0245910 A1
(43) Pub. Date: Oct. 25, 2007

(54) Golf ball holder for holding a golf ball while drawing a circle on the golf ball

(76) Inventor: Shao-Fu Hung, Taichung Hsien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/410,806

(22) Filed: Apr. 24, 2006

(51) Int. Cl. B41F 17/00

(52) U.S. Cl. 101/35; 101/DIG. 40; 473/351

(57) ABSTRACT

A golf ball holder is adapted to hold a golf ball while drawing a circle on the golf ball using a pen, and includes a supporting plate adapted to support the golf ball thereon, and an annular surrounding unit disposed on the supporting plate. The surrounding unit is adapted to be disposed around the golf ball such that a lower half portion of the golf ball is disposed within the surrounding unit and an upper half portion of the golf ball is disposed outwardly of the surrounding unit. The inner diameter of the surrounding unit is approximately equal to the diameter of the golf ball. The surrounding unit is structured so as to allow a pen to slide on the surrounding wall, thereby drawing the circle on the golf ball.

### BACKGROUND OF THE INVENTION

1. Field of the Invention

This invention relates to an instrument for use with practice golf balls, and more particularly to a golf ball holder for holding a golf ball while drawing a circle on the golf ball.

2. Description of the Related Art

Referring to FIGS. 1 to 3, a conventional golf ball holder 10 includes a lower housing half 11, an upper housing half 12 connected pivotally to and cooperating with the lower housing half 11 to define a ball-accommodating space 13 for receiving a practice golf ball 20, a lower retainer 14 disposed on a free end of the lower housing half 11, and an upper retainer 15 disposed on a free end of the upper housing half 12 and connected removably to the lower retainer 14 so as to prevent pivoting movement of the upper housing half 12 relative to the lower housing half 11. The lower housing half 11 is formed with a central hole 111 through a lower end thereof. As such, a finger of the user can contact and roll the golf ball 20 so as to change the position of the golf ball 20 within the golf ball holder 10. The upper housing half 12 is formed with a curved slot 121 at an upper end, and a row of holes 122 in the form of English letters (A, B, C, D, E, F, G) at a lower end. A pen 30 can be inserted into the slot 121 to draw a line on the golf ball 20, as shown in FIG. 2, or into a selected one of the holes 122 to mark the corresponding English letter on the golf ball 20.

The aforesaid conventional golf ball holder 10 suffers from the following disadvantages:
(1) The structure of the golf ball holder 10 is complicated.
(2) When the pen 30 is inserted into the slot 121 or one of the holes 122 in the upper housing half 12 to perform line-drawing or letter-marking, the golf ball 20 rolls within the golf ball holder 10. As a result, it is difficult to precisely draw a line or provide letter markings on the golf ball 20.

### SUMMARY OF THE INVENTION

An object of this invention is to provide a golf ball holder that has a simple structure. Another object of this invention is to provide a golf ball holder that is structured so as to allow a golf ball to be anchored to the ball holder while drawing a circle on the golf ball.

According to this invention, a golf ball holder is adapted to hold a golf ball while drawing a circle on the golf ball using a pen, and includes a supporting plate adapted to support the golf ball thereon, and an annular surrounding unit disposed on the supporting plate. The surrounding unit is adapted to be disposed around the golf ball such that a lower half portion of the golf ball is disposed within the surrounding unit and an upper half portion of the golf ball is disposed outwardly of the surrounding unit. The inner diameter of the surrounding unit is approximately equal to the diameter of the golf ball. The surrounding unit is structured so as to allow a pen to slide on the surrounding wall, thereby drawing the circle on the golf ball. Since the upper half portion of the golf ball is exposed to the outside of the golf ball holder, while the circle is being drawn on the golf ball, the golf ball can be anchored within the golf ball holder by the surrounding unit or a finger of the user. As such, the circle can be drawn precisely on the golf ball.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a perspective view of a conventional golf ball holder and a golf ball;

FIG. 2 is a schematic side view of the conventional golf ball holder, illustrating how a line is drawn on the golf ball within the golf ball holder by a pen;

FIG. 3 is a schematic side view of the conventional golf ball holder, illustrating how the golf ball is rolled within the golf ball holder;

FIG. 4 is a perspective view of the first preferred embodiment of a golf ball holder according to this invention, and a golf ball that may be placed in the golf ball holder;

FIG. 5 is a sectional view of the first preferred embodiment, illustrating how a circle is drawn on the golf ball by a pen;

FIG. 6 is a sectional view of the first preferred embodiment, illustrating how the golf ball is anchored within the golf ball holder;

FIG. 7 is a top view of the first preferred embodiment, illustrating sliding movement of the pen on a surrounding wall;

FIG. 8 is a sectional view of the second preferred embodiment of a golf ball holder according to this invention;

FIG. 9 is a top view of the second preferred embodiment;

FIG. 10 is a sectional view of the third preferred embodiment of a golf ball holder according to this invention;

FIG. 11 is a sectional view of the fourth preferred embodiment of a golf ball holder according to this invention; and

FIG. 12 is a perspective view of a golf club and a practice golf ball, illustrating how a line indicated on the golf club is aligned with one circle indicated on the golf ball.

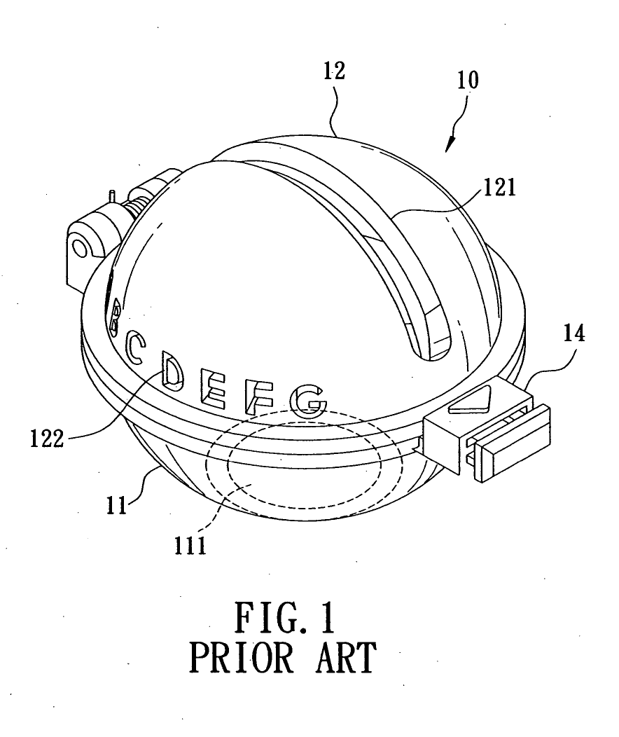

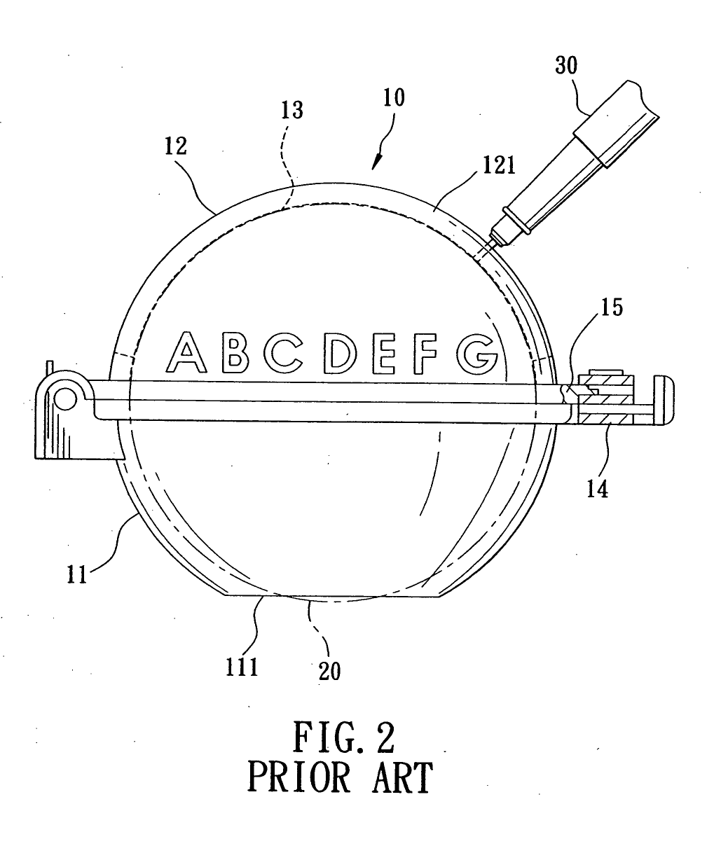

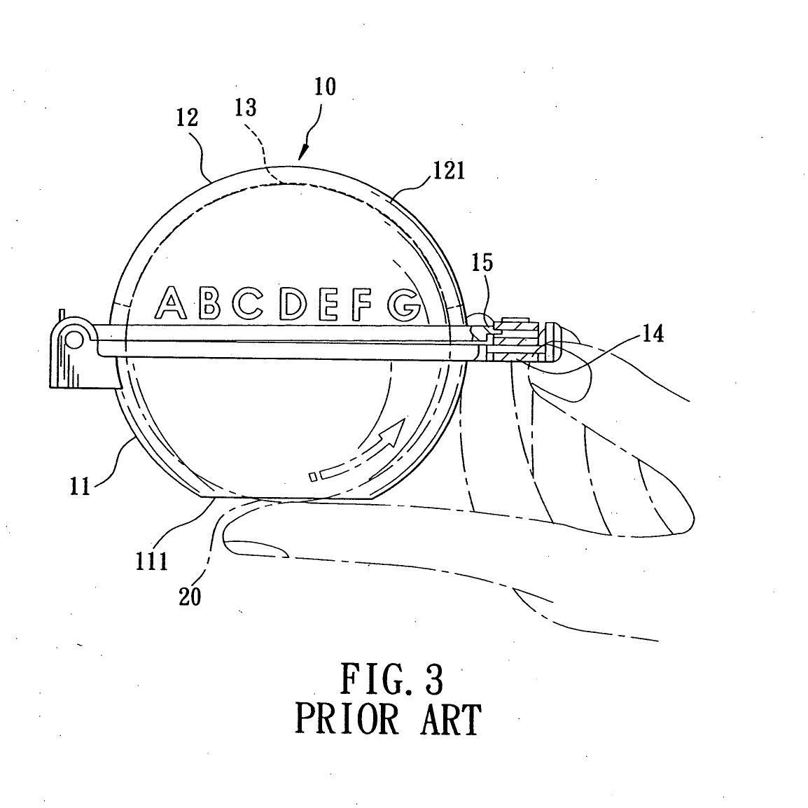

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

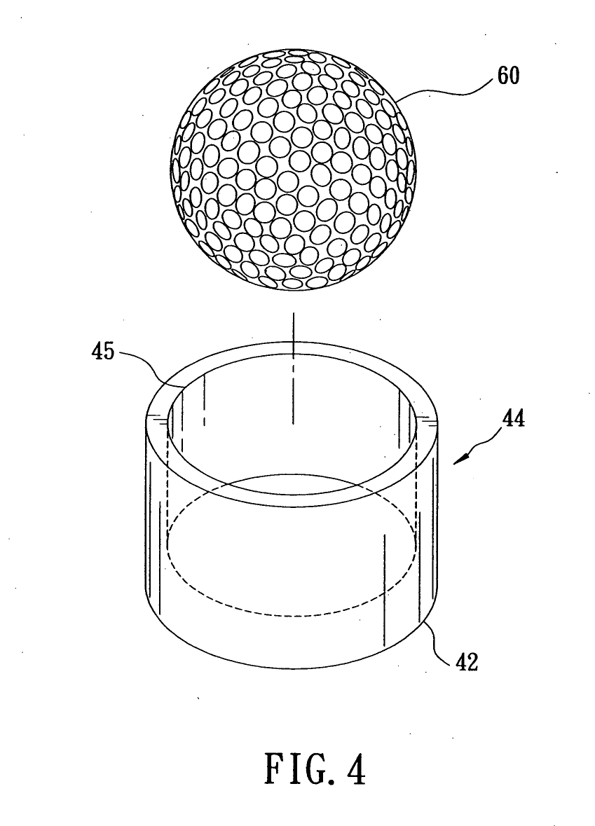

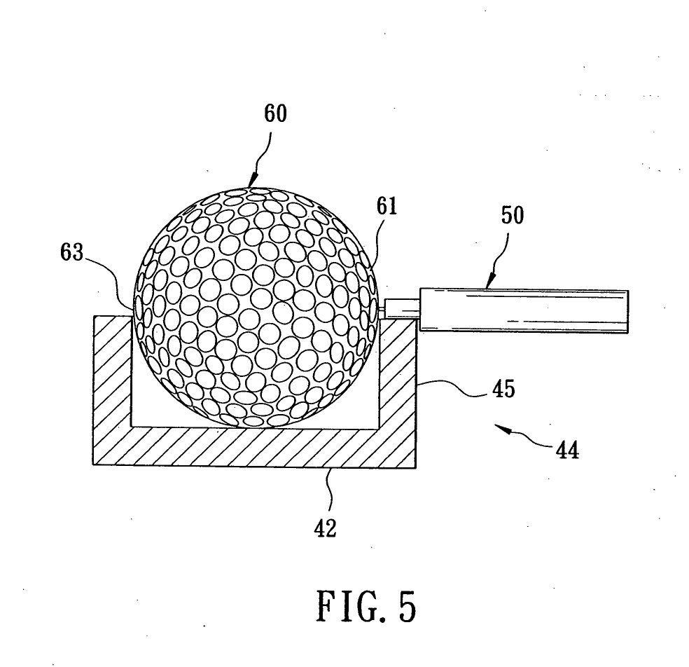

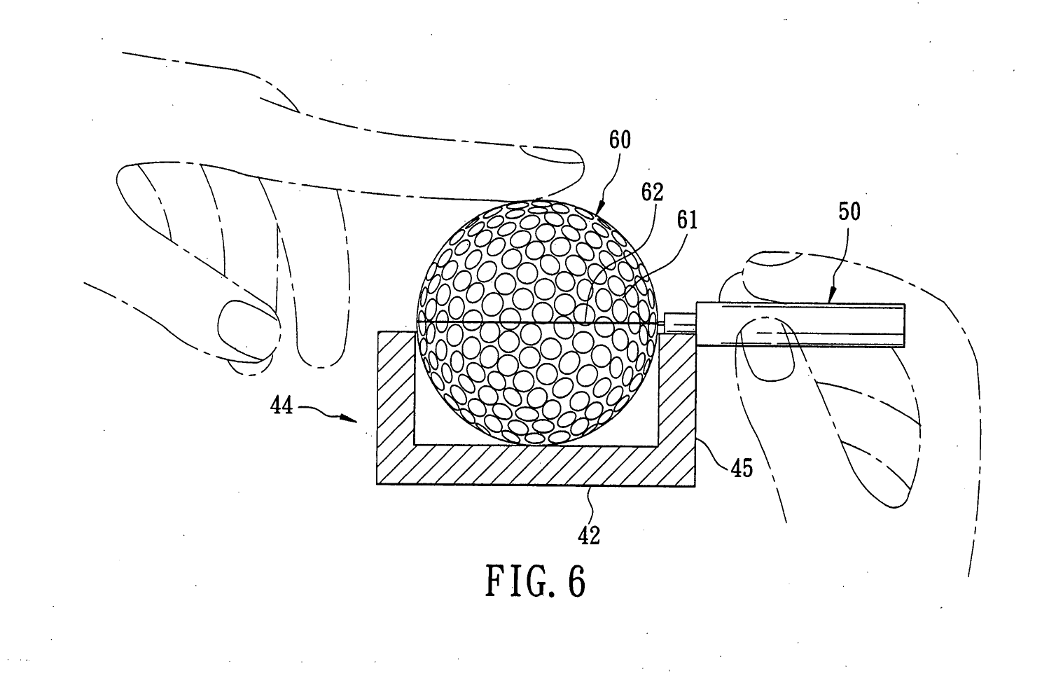

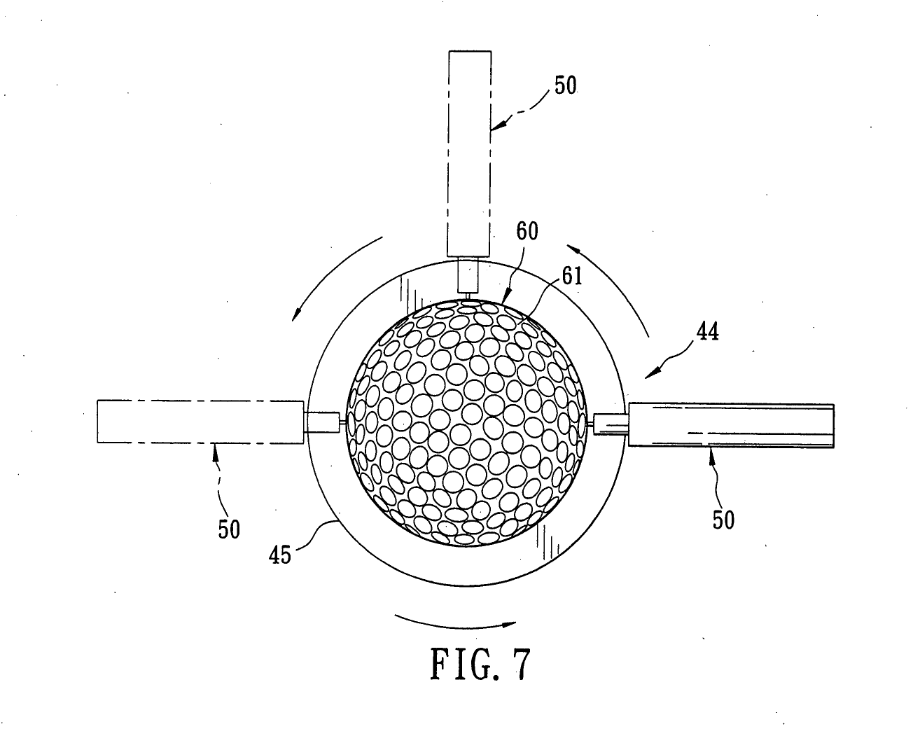

Referring to FIGS. 4, 5, and 6, the preferred embodiment of a golf ball holder according to this invention is adapted to hold a practice golf ball 60 while drawing a circle 62 on an outer surface 61 of the golf ball 60 using a pen 50. The golf ball holder includes a circular supporting plate 42 adapted to support the golf ball 60 thereon, and an annular surrounding unit 44 disposed on the supporting plate 42. The surrounding unit 44 is disposed around the golf ball 60 such that a lower half portion of the golf ball 60 is disposed within the surrounding unit 44 and an upper half portion of the golf ball 60 is disposed outwardly of the surrounding unit 44. The surrounding unit 44 has an inner diameter approximately equal to the diameter of the golf ball 6, and is structured so as to allow the pen 50 to slide on the surrounding unit 44, thereby drawing the circle 62 on an outer periphery 63 of the golf ball 60, as shown in FIGS. 6 and 7.

In this embodiment, the surrounding unit 44 includes a cylindrical surrounding wall 45 extending integrally and upwardly from an outer periphery of the supporting plate 42. The surrounding wall 45 has an inner diameter slightly greater than the diameter of the golf ball 60. When it is desired to draw the circle 62 on the golf ball 60, a finger of the user presses downwardly against an upper end of the golf ball 60. Thus, the golf ball 60 is anchored to the supporting plate 42. Subsequently, the pen 50 is moved on an upper end surface of the surrounding wall 45 to draw the circle 62 on the golf ball 60.

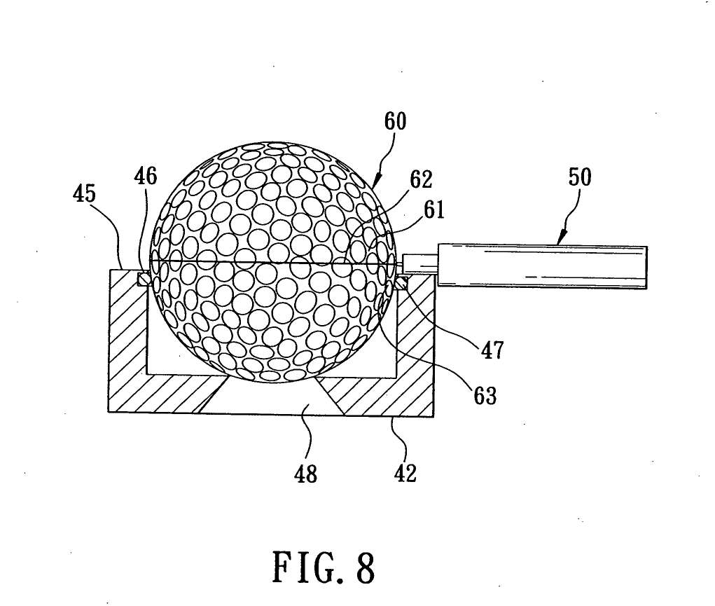

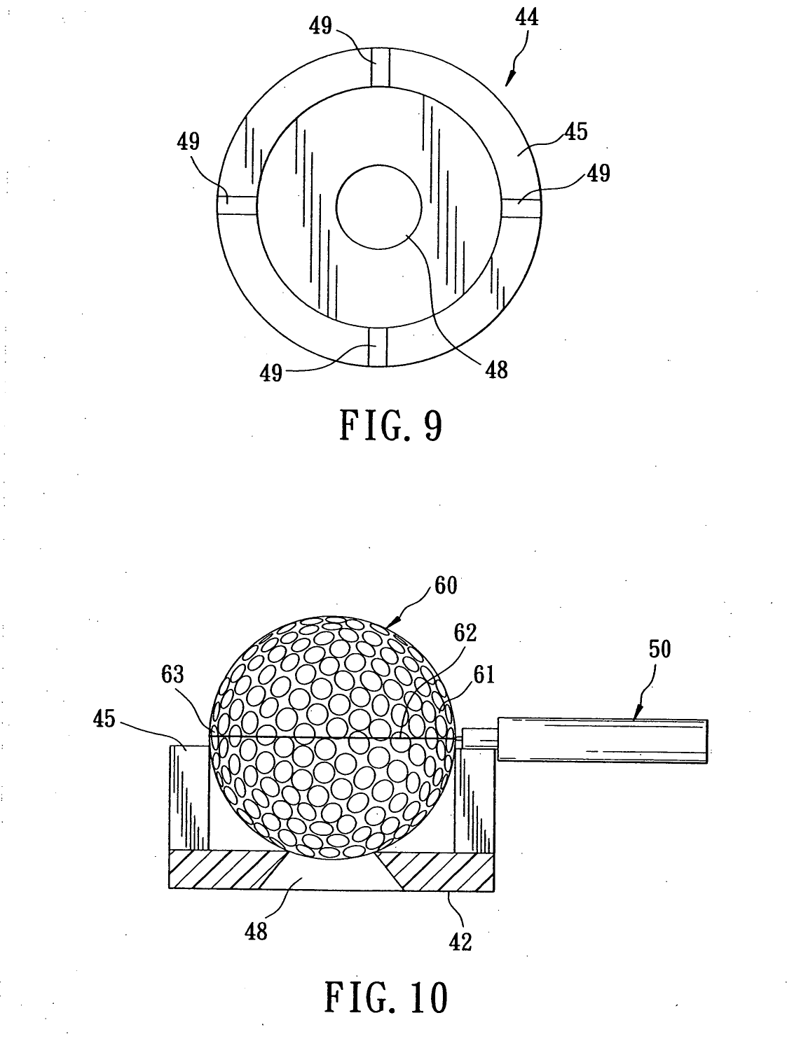

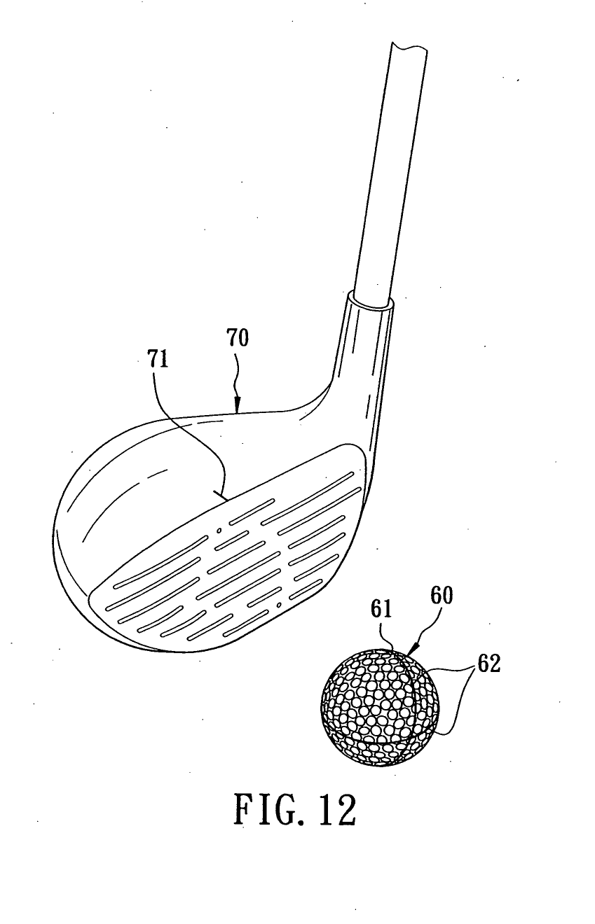

FIGS. 8 and 9 show the second preferred embodiment of a golf ball holder according to this invention, which is a modification of the first preferred embodiment. In this embodiment, the surrounding wall 45 is formed with an annular groove 46 in an annular inner surface thereof. The annular groove 46 is disposed under and adjacent to an upper end of the surrounding wall 45. A retaining ring 47 is received within the annular groove 46 in the inner surface of the surrounding wall 45, and is in frictional contact with the inner surface of the surrounding wall 45 and the outer periphery 63 of the golf ball 60 so as to prevent rolling movement of the golf ball 60 on the supporting plate 42. The retaining ring 47 is configured as an O-ring or a C-shaped retaining ring, and is made of rubber. The supporting plate 42 has a hole 48 formed therethrough. As such, a finger of the user can be inserted through the hole 48 and into a space defined by the surrounding wall 45. Hence, the golf ball 60 is ejected from the golf ball holder. In this embodiment, the hole 48 is frustoconical, and has a diameter reducing upwardly. An annular upper end surface of the supporting wall 45 is formed with four angularly equidistant slots 49. Each of the slots 49 has two open ends, and extends along a radial direction of the surrounding wall 45. Due to the presence of the slots 49 in the surrounding wall 45, two perpendicularly intersecting circles 60 (see FIG. 12) can be drawn easily on the golf ball 60, as described in the succeeding paragraph.

After a first circle 62 has been drawn on the golf ball 60, the golf ball 60 is rotated so as to align the first circle 62 with any two opposing ones of the slots 49. Then, a second circle 62 can be drawn on the golf ball 60 in the same manner as shown in FIG. 7.

With further reference to FIG. 12, when the two circles 62 are drawn on the golf ball 60, a mark 71 of a golf club 70 can be aligned conveniently with either of the circles 62.

FIG. 10 shows the third preferred embodiment of a golf ball holder according to this invention, which is similar in construction to the first preferred embodiment except that the inner surface of the surrounding wall 45 is in frictional contact with the outer periphery 63 of the golf ball 60, and the supporting plate 42 is formed with the hole 48. In this embodiment, the surrounding wall 45 is made of rubber or a plastic material, and the inner diameter of the surrounding wall 45 is equal to or slightly smaller than the diameter of the golf ball 60. Due to the frictional contact between the surrounding wall 45 and the golf ball 60, rolling movement of the golf ball 60 on the supporting plate 42 is prevented.

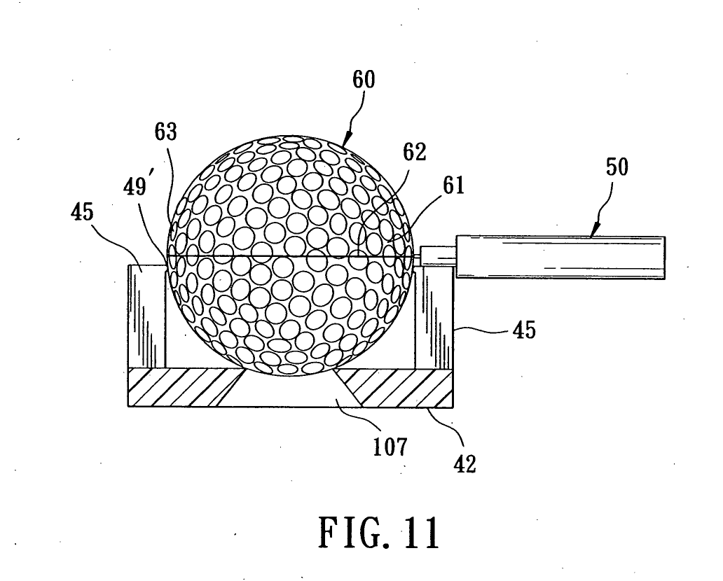

FIG. 11 shows the fourth preferred embodiment of a golf ball holder according to this invention, which is similar in construction to the first preferred embodiment except that an upper end of the surrounding wall 45 is formed with an inward flange 49′ extending radially and inwardly therefrom. The inward flange 49′ is in frictional contact with the outer periphery 63 of the golf ball 60 so as to prevent rolling movement of the golf ball 60 on the supporting plate 42.

The golf ball holder of this invention has the following advantages:
(1) The structure of the golf ball holder is simple.
(2) The golf ball 60 can be anchored within the golf ball holder by the surrounding unit 44 or the finger of the user when the circle 62 is being drawn on the golf ball. Therefore, the circle 62 can be drawn precisely on the golf ball 60.

With this invention thus explained, it is apparent that numerous modifications and variations can be made without departing from the scope and spirit of this invention. It is therefore intended that this invention be limited only as indicated by the appended claims.

I claim:

1. A golf ball holder adapted to hold a golf ball while drawing a circle on the golf ball using a pen, said golf ball holder comprising:
a supporting plate adapted to support the golf ball thereon; and
an annular surrounding unit disposed on said supporting plate and adapted to be disposed around the golf ball such that a lower half portion of the golf ball is disposed within said surrounding unit and an upper half portion of the golf ball is disposed outwardly of said surrounding unit, said surrounding unit having an inner diameter approximately equal to the diameter of the golf ball, and being structured so as to allow a pen to slide on said surrounding unit, thereby drawing the circle on the golf ball.

2. The golf ball holder as claimed in claim 1, wherein said supporting plate is circular, and said surrounding unit includes a cylindrical surrounding wall extending integrally and upwardly from an outer periphery of said supporting plate and having an inner diameter slightly greater than the diameter of the golf ball.

3. The golf ball holder as claimed in claim 2, wherein said surrounding wall has an annular inner surface that is formed with an annular groove, which is disposed under and adjacent to an upper end of said surrounding wall, said golf ball holder further comprising a retaining ring that is received within said annular groove in said inner surface of said surrounding wall and that is in frictional contact with said inner surface of said surrounding wall and the outer periphery of the golf ball so as to prevent rolling movement of the golf ball on said supporting plate.

4. The golf ball holder as claimed in claim 3, wherein said retaining ring is configured as an O-ring.

5. The golf ball holder as claimed in claim 3, wherein said retaining ring is configured as a C-shaped retaining ring.

6. The golf ball holder as claimed in claim 1, wherein said supporting plate has a hole formed therethrough so that a finger of a user can be inserted into said surrounding unit via said hole in said supporting plate, thereby ejecting the golf ball from said surrounding unit.

7. The golf ball holder as claimed in claim 6, wherein said hole in said supporting plate is frustoconical, and has a diameter reducing upwardly.

8. The golf ball holder as claimed in claim 1, wherein said supporting plate is circular, and said surrounding unit includes a cylindrical surrounding wall extending integrally and upwardly from an outer periphery of said supporting plate and having an inner diameter approximately equal to the outer periphery of the golf ball, said supporting wall having an annular upper end surface formed with four angularly equidistant slots, each of said slots having two open ends and extending along a radial direction of said surrounding wall.

9. The golf ball holder as claimed in claim 1, wherein said supporting plate is circular, and said surrounding unit includes a cylindrical surrounding wall extending integrally and upwardly from an outer periphery of said supporting plate and having an annular inner surface in frictional contact with the outer periphery of the golf ball.

10. The golf ball holder as claimed in claim 1, wherein said supporting plate is circular, and said surrounding unit includes a cylindrical surrounding wall extending integrally and upwardly from an outer periphery of said supporting plate and having an inner diameter slightly greater than the outer periphery of the golf ball, said surrounding wall having an upper end that is formed with an inward flange extending radially and inwardly therefrom, said inward flange being in frictional contact with the golf ball so as to prevent rolling movement of the golf ball on said supporting plate.
